(19) United States
(12) Patent Application Publication
(10) Pub. No.: US 2006/0019050 A1
(43) Pub. Date: Jan. 26, 2006

(54) Perforated adhesive label and method of making same

(76) Inventor: Phyllis A. Gilmer, South Lyon, MI (US)

Correspondence Address: NATH & ASSOCIATES, PLLC, Sixth Floor, 1030 15th Street, N.W., Washington, DC, 20005, US

(21) Appl. No.: 11/071,295

(22) Filed: Mar. 4, 2005

Related U.S. Application Data
(60) Provisional application No. 60/590,438, filed on Jul. 23, 2004.

(51) Int. Cl. B32B 33/00

(52) U.S. Cl. 428/40.1; 428/43

(57) ABSTRACT

Embodiments of the disclosed inventive adhesive notepad are adapted to contain any sheet of paper can be removed from the notepad without the need to remove other sheets. Embodiments of sheets of the disclosed notepad include a pressure sensitive adhesive attached at different positions on each sheet allowing for removal of a single sheet of paper from the notepad in various ways.

The present invention claims the benefit of the filing date of U.S. Provisional Patent Application Ser. No. 60/590,438 filed on Jul. 23, 2004, which is herein incorporated by reference.

### FIELD OF TECHNOLOGY

This invention generally relates to paper that is provided in the form of a note pad having adhesively and integrally attached sheets, and enabling individual sheets to be separated from the pad as desired.

### BACKGROUND

Removable adhesive note pads are known in the prior art. For example, the Minnesota Mining and Manufacturing Company (“3M”) of St. Paul, Minn., markets a pad, having a pressure-sensitive adhesive. The 3M pad is commercially known under the trademark “POST-IT.” The “POST-IT” note pad article and other generic self-stick removable note pads of a paper type allow for the removal of a top sheet of paper of the note pad; however, removal of intermediary sheets of the note pad are not possible without significantly ruining the adhesive pad. If the intermediary sheets are used and separated from the pad of sheets, all of the sheets existing above the intermediary sheet that are removed from the pad cause the entire pad to become separated into multiple parts, hence the original note pad becomes two or more separate pads. Eventually, if it is necessary to continue using intermediary sheets of paper, what was once a single pad will become multiple pads, some of which can become wrinkled, dirty and unusable on areas including the adhesive area. Keeping the note pads intact as one single pad will eliminate waste and deterioration of the sheets of the pad.

These disadvantages and drawbacks in the use of known self-stick removable note pads is universally observed and encountered. It is during or after this process that people often encounter disappointment or even frustration as they manage to remove an intermediary sheet of paper from the pad after finishing their writing and then attempt to re-join the two separate pads only to find that the adhesive is no longer strong enough to maintain the integrity of the pad. The prior art has not attempted to overcome this problem; in fact, the problem seems to be one of first impression as users of removable adhesive pads have been content to remove intermediary sheets of paper from a pad by separating the pad in two and then rejoining the pads.

Therefore, known adhesive pads are not entirely satisfactory. There is a need in the art for self-stick note pads that readily permit the user to easily remove an intermediary sheet of paper from the pad without disturbing the integrity of the pad.

### BRIEF SUMMARY OF ASPECTS OF THE INVENTION

An embodiment of the inventive note pad includes a plurality of sheets of paper bound by a backing layer, a plurality of holes disposed at a distance from a first edge of each of the plurality of sheets of paper; the plurality of sheets of paper including a pressure sensitive adhesive strip disposed on one side of each sheet of paper and at a predetermined distance from the first edge of the plurality of sheets of paper and having a degree of tackiness. The adhesive strip extends from a first side edge of each of the plurality of sheets of paper to a second side edge of the sheet of paper. The adhesive strip further has a width that is less than half of the width of each of the plurality of sheets of paper. In this embodiment, the adhesive strip is not the primary binder of the plurality of sheets of paper. However, the adhesive strip can be a secondary binder of the sheets of paper. The note pad can have any number of shapes, e.g. square, rectangular, triangular, polygonal, octagonal, hexagonal, round, etc.

A further embodiment of the inventive note pad includes a plurality of sheets of paper bound by a backing, a plurality of holes disposed at a distance from a first edge of each of the sheets of paper, and a pressure sensitive adhesive strip disposed on one side of each sheet of paper. The adhesive strip is positioned at a predetermined distance from a second edge of the sheet of paper and has a degree of tackiness. The adhesive strip extends from a first side edge of the sheet of paper to a second side edge of the sheet of paper and further has a width that is less than half of the width of the sheet of paper.

Yet a further embodiment of the notepad includes a plurality of sheets of paper bound by a backing; a plurality of holes disposed at a distance from a first edge of each of the plurality of sheets of paper, and an adhesive. The adhesive strip extends from a first side edge of the sheets of paper to a second side edge of the sheets of paper. The adhesive strip further has a width that is less than half of the width of the plurality of sheets of paper and is disposed on at least the first side edge of at least one of the plurality of sheets of paper.

Still another embodiment of the notepad can include a second adhesive strip disposed on a second edge of at least one of a plurality of sheets of paper. The second adhesive strip can be positioned on a second edge of the plurality of sheets of paper that is opposite the first edge (in a square pad for example), or on an edge that is disposed at a position that is in a location other than the position of the first adhesive strip.

The holes in the sheets of paper are perforations of the note pad and allow for ease of separation within any portion of the note pad while preventing separation of the note pad into multiple portions. Additionally, a portion of each sheet above the perforated line will identify the use of each sheet and to whom it might have been sent/posted. The note pads may be available in various sizes and colors and the perforations may be available in various shapes such as squares, multi-pointed stars, triangles, circles, trapezoids, crosses, parallelograms, and other geometric shapes.

The note pad can have a plurality of sheets glued together at an edge with adhesive. The top portion (writing surface) of each sheet may allow for identification of the recipient and the subject. Under the recipient and subject line is a perforated line where the sheet(s) can be separated from the pad. A portion of the backside of the sheet (below the perforation) has adhesive that allows for the sheet to adhere to other surfaces once the sheet is separated from the note pad. The bottom portion located on the same side as the adhesive may also be used as a writing surface.

There are other alternative or preferred features or aspects. They will become apparent as this specification proceeds. In this regard, this Brief Summary of Aspects of the Invention is not to be construed as itself limiting of the invention or various aspects of the invention or its preferred embodiments or as requiring that a given embodiment of the invention must include all features or advantages recited herein.

### BRIEF DESCRIPTION OF THE DRAWINGS

FIG. 1 is a perspective view of a pad of perforated adhesive labels.

FIG. 2 is a view of a backside of an embodiment of a single adhesive label.

FIG. 3 is a view of a backside of an embodiment of a single adhesive label.

FIG. 4 is a perspective view of a pad of perforated adhesive labels with a single interior sheet emphasized.

FIG. 5 is a view of a backside of an embodiment of a single adhesive label.

FIG. 6 is a view of a backside of an embodiment of a single adhesive label.

### DETAILED DESCRIPTION OF THE PREFERRED EMBODIMENTS

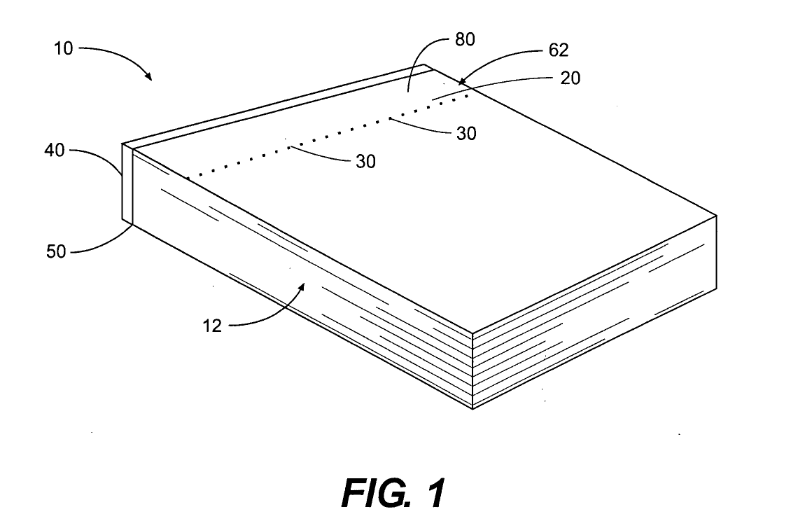

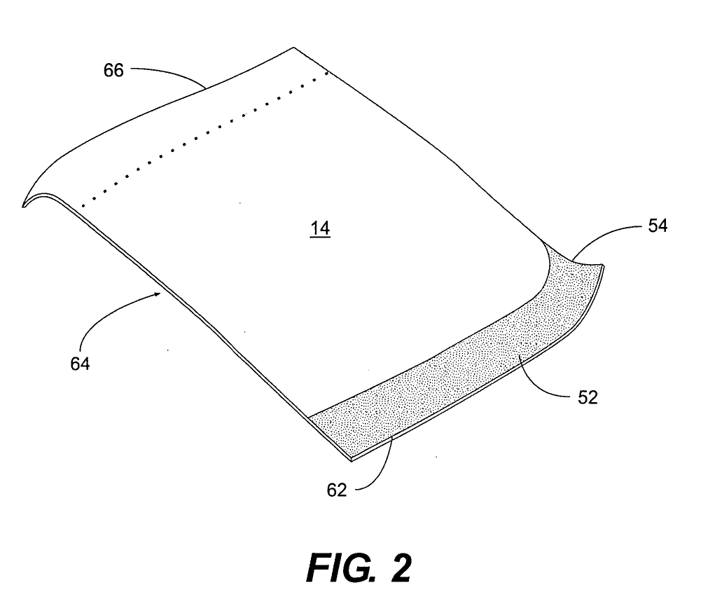

Referring first to FIGS. 1 and 2, an embodiment of the inventive adhesive pad is generally depicted as a pad 10 having a plurality of perforated adhesive sheets 12. A line 20 of perforations 30 is positioned on the pad 10 in a manner that allows a person to easily remove a single perforated sheet 12 from the pad 10. An adhesive 50 is located on a spine 40 of the plurality of sheets 12. The spine is unnecessary in this embodiment, but can be used to further secure each of the plurality of sheets 12 in pad 10. Although the perforations 30 are shown here in a straight horizontal line with respect to the edge of the sheet, it is contemplated that lines having other shapes such as wavy and zigzag, and orientations such as diagonal, skewed, and horizontal in combination with vertical (for a two-sided note pad) can be used.

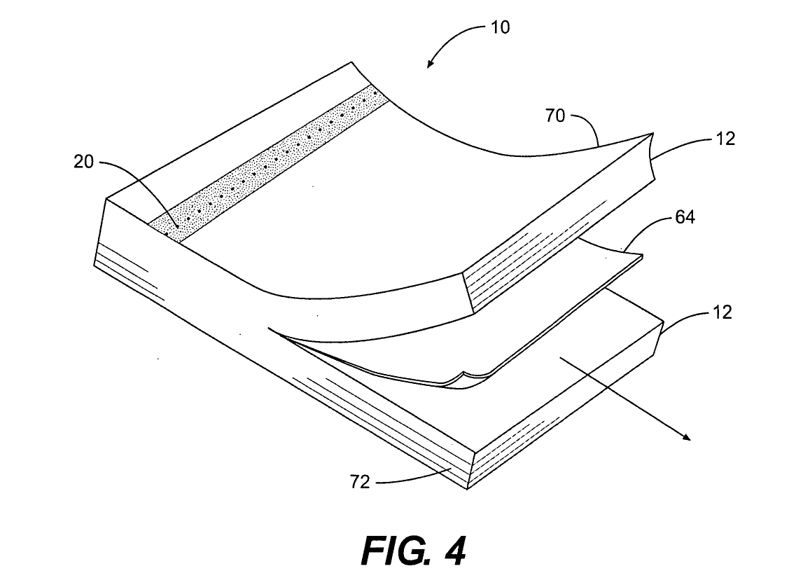

In this embodiment, a tacky or pressure sensitive adhesive 52 is located on a bottom surface 14 of each of the plurality of sheets 12 near a bottom edge 62 of the pad 10. To facilitate removal of a single adhesive sheet 64 from the pad 10, the adhesive 52 is located on a bottom edge 52 of the pad 10 that is opposite a top edge 66. As such, the sheet 64 can be removed from the middle or any location including the top or bottom of the pad 10 by separating the single sheet 64 from the plurality of sheets 12, as shown generally in FIG. 4, by tearing the sheet 64 out of the pad 10 at the line 20 of perforations 30. The adhesive sheet 64 can then be applied to any surface.

As shown in FIG. 4, a second embodiment can be characterized by a tacky or pressure sensitive adhesive 102 being located on a bottom surface 114 of each sheet 122 of an adhesive pad (not shown) adjacent or near a line 104 of perforations 106 on a middle section 108 of each sheet 122. In this second embodiment, the sheets are generally bound on a first end 116 by a spine as in the first embodiment. The tacky adhesive 102 is positioned on each sheet 122 such that if a sheet 122 is removed from the pad, it will contain adhesive along an edge 120 thereof. As such, a single sheet 122 can be removed from the pad by separating the single sheet 122 from the other sheets by tearing the sheet 122 out of the pad at the line 104 of perforations 106. The sheet 122 can then be applied to a surface of an object.

As shown further in FIG. 4, to remove the sheet 64 from a location in the pad other than where the top sheet is located, a user must lift upper sheets 70 from the sheet 64 desired to be removed and then lift the desired sheet 64 from lower sheets 72. The adhesive 52 (not shown in FIG. 4) on the sheet 64 will readily allow the sheet 64 to release from the lower sheets 72. Then, a person must simply pull on a bottom end 54 (shown only in FIG. 4) of the sheet 64 with a sufficient amount of force such that the sheet 64 releases from the spine 40. The pad 10 is left in tact for further use and the sheet 64 can be applied to any surface. This method of removing a sheet is generally applicable to all of the embodiments of the present invention.

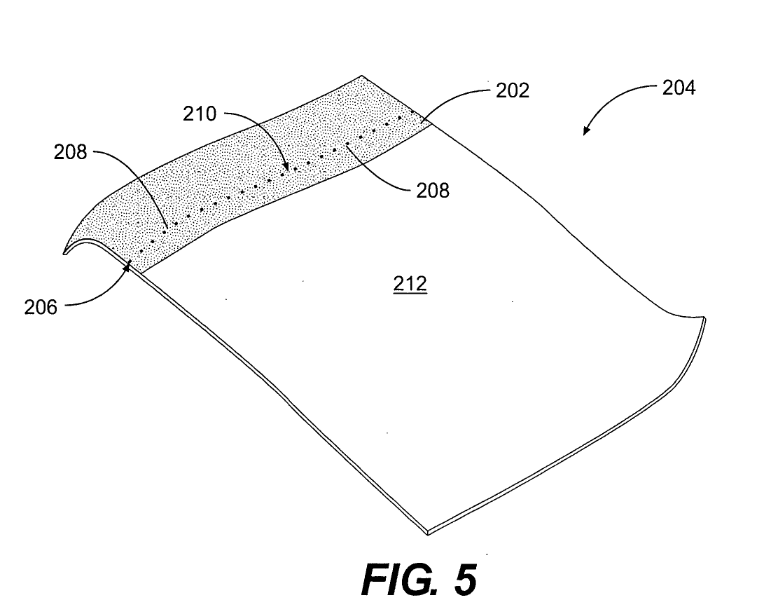

As shown in FIG. 5, a third embodiment can be characterized by a tacky adhesive 202 being located on a bottom surface 212 of a sheet 204 such that a line 206 of perforations 208 is completely surrounded by the tacky adhesive 202. The tacky adhesive 202 is positioned on the sheet 204 such that if the sheet 204 is removed from the pad (not shown), it will contain adhesive along a top edge 210 thereof. As such, single sheet 204 can be removed from the middle of the pad by separating the single sheet from the other sheets as generally shown in FIG. 4 with respect to the first embodiment of the present invention. In this third embodiment, a spine is not necessary, as the tacky adhesive maintains the integrity of the pad of adhesive sheets. The sheet 204 can then be applied to any surface.

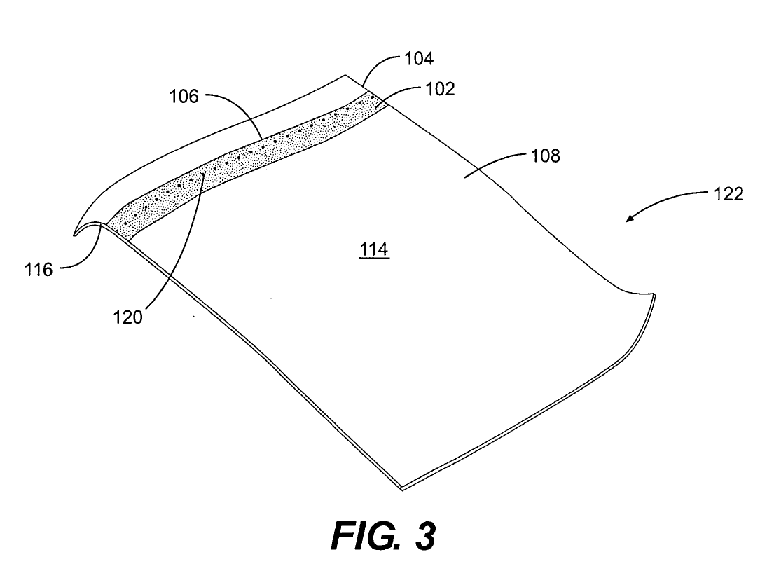

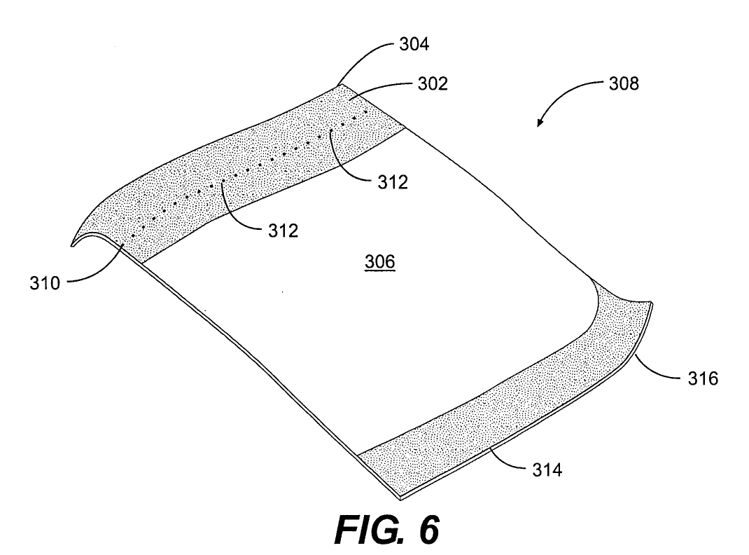

As shown in FIG. 6, a fourth embodiment of the present invention can be characterized by a first tacky or pressure sensitive adhesive 302 being located on a top edge 304 of a bottom surface 306 of a sheet 308 in multiple locations such that a line 310 of perforations 312 is completely surrounded by the first tacky adhesive 302 and such that a second tacky adhesive 314 is on a bottom edge 316 opposite the top edge 304. The first and second tacky adhesives 302 and 314 are positioned on the sheet 308 such that if the sheet 308 is removed from a pad (not shown), the sheet 308 will contain adhesive along both edges 304 and 316 thereof. As such, a single sheet can be removed from the middle of the pad by separating the single sheet from the other sheets, as shown generally in FIG. 3 with respect to the first embodiment of the present invention. In this fourth embodiment, a spine is not necessary, as the tacky adhesive 302 maintains the integrity of the pad of adhesive sheets. The sheet 308 can then be applied to a surface of an object.

I claim:

1. A pad comprising:
a plurality of sheets of paper;
a plurality of holes disposed at a distance from a first edge of at least one of the plurality of sheets of paper;
the at least one sheet of paper including an adhesive strip disposed on a portion of one surface thereof and at a predetermined distance from the first edge of the at least one sheet,
wherein the adhesive strip is pressure sensitive and has a degree of tackiness, and extends intermittently from a first side edge of the at least one sheet of paper to a second side edge of the at least one sheet of paper, and
wherein the adhesive strip further includes a width that is less than half of the width of the at least one sheet of paper. The pad of claim 1 wherein the plurality of sheets of paper has a polygonal shape.

2. The pad of claim 1 wherein the adhesive strip surrounds the plurality of holes.

3. The pad of claim 2 wherein the plurality of holes is at a centerline of the adhesive strip.

4. The pad of claim I wherein the adhesive strip is halfway between the plurality of holes and a side opposite the first edge of the at least one of the plurality of sheets of paper.

5. A pad comprising:
a plurality of sheets of paper;
a plurality of holes disposed at a distance from a first edge of at least one of the plurality of sheets of paper;
the at least one sheet of paper including an adhesive strip disposed on one side thereof and at a predetermined distance from a second edge of the at least one sheet of paper and surrounds the plurality of holes,
wherein the adhesive strip is pressure sensitive and has a degree of tackiness and extends from a first side edge of the at least one sheet of paper to a second side edge of the at least one sheet of paper, and
wherein the adhesive strip further has a width that is less than half of the width of the sheet of paper.

6. The pad of claim 1 wherein a second adhesive strip is disposed on the first edge of the at least one sheet of paper.

7. The pad of claim 6 wherein the first edge and second edge are arranged opposite each other.

8. The pad of claim 5 wherein the pad has a polygonal shape.

9. A pad comprising:
a plurality of sheets of paper;
a plurality of holes disposed at a distance from a bound edge of at least one of the plurality of sheets of paper;
the at least one sheet of paper including an adhesive strip having a degree of tackiness;
wherein the adhesive strip extends from a first side edge of the at least one sheet of paper to a second side edge of the at least one sheet of paper and surrounds the plurality of holes,
wherein the adhesive strip further has a width that is less than half of the width of the sheet of paper, and
wherein the adhesive strip is disposed on at least the first side edge of the at least one sheet of paper and binds the plurality of sheets of paper.

10. The pad as recited in claim 9 further including a second adhesive strip disposed on a second edge of the at least one sheet of paper.

11. The pad as recited in claim 10 wherein the second edge is positioned opposite the first edge.
